(19) United States
(12) Patent Application Publication
(10) Pub. No.: US 2026/0128866 A1
(43) Pub. Date: May 7, 2026

(54) FILS PUBLIC KEY AUTHENTICATION AND PRIVATE PMKID CALCULATION

(71) Applicant: Intel Corporation, Santa Clara, CA (US)

(72) Inventors: Po-Kai Huang, San Jose, CA (US); Ilan Peer, Modiin Jm (IL); Johannes Berg, Detmold (DE); Ido Ouzieli, Tel Aviv (IL)

(21) Appl. No.: 19/427,925

(22) Filed: Dec. 19, 2025

Related U.S. Application Data
(60) Provisional application No. 63/797,009, filed on Apr. 29, 2025.
(60) Provisional application No. 63/819,316, filed on Jun. 6, 2025.

(51) Int. Cl. H04L 9/08; H04L 9/30; H04L 9/32

(52) U.S. Cl. CPC H04L 9/0825; H04L 9/30; H04L 9/3236; H04L 9/3247

(57) ABSTRACT

A wireless device and system are described to provide enhanced privacy in 802.11 association and Reassociation procedures. To avoid an access point (AP)-only modification of the Pairwise Master Key Identifier (PMKID) during (Re)Association, Nonces are exchanged by both a non-AP station (STA) and the AP to derive a new PMKID. In addition, fast initial link setup (FILS) public key authentication is adjusted to move the signature of the FILS Responder to the second Authentication rather than the (Re)Association Response frame. In addition, an identity key is included in the Pairwise Master Key (PMK) or Pairwise Transient Key (PTK) derivation.

### PRIORITY CLAIMS

This application claims priority under 35 U.S.C. 119(e) to U.S. Provisional Patent Application Ser. No. 63/797,009, filed, Apr. 29, 2025, and U.S. Provisional Patent Application Ser. No. 63/819,316, filed, Jun. 6, 2025, each which are incorporated herein by reference in their entireties.

### TECHNICAL FIELD

Embodiments pertain to wireless communications. Some embodiments relate to key-based authentication in wireless local area networks (WLANs).

### BACKGROUND

Wireless devices are becoming widely prevalent and are increasingly requesting access to wireless channels. The Institute of Electrical and Electronics Engineers (IEEE) is developing standards for wireless local area networks (WLANs). The complexity of such communication systems, as well as interactions between stations (STAs) within a WLAN system, has increased. In particular, security continues to be an issue in various communications between STAs, as Wi-Fi 8 (IEEE 802.11bn or bi) and further standards continue to be developed.

### BRIEF DESCRIPTION OF THE DRAWINGS

FIG. 1 is a block diagram of a radio architecture, in accordance with some embodiments.

FIG. 2 illustrates a front-end module circuitry for use in the radio architecture of FIG. 1, in accordance with some embodiments.

FIG. 3 illustrates a radio IC circuitry for use in the radio architecture of FIG. 1, in accordance with some embodiments.

FIG. 4 illustrates a baseband processing circuitry for use in the radio architecture of FIG. 1, in accordance with some embodiments.

FIG. 5 illustrates a WLAN, in accordance with some embodiments.

FIG. 6 illustrates a multi-link framework in accordance with some embodiments.

FIG. 7 illustrates network environment of enhanced link security in accordance with some embodiments.

FIG. 8 illustrates a frame exchange in accordance with some embodiments.

FIG. 9 illustrates a fast initial link setup (FILS) public key element format in accordance with some embodiments.

FIG. 10 illustrates a privacy beam frame format in accordance with some embodiments.

FIG. 11 illustrates a flow diagram for an enhanced link security system in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

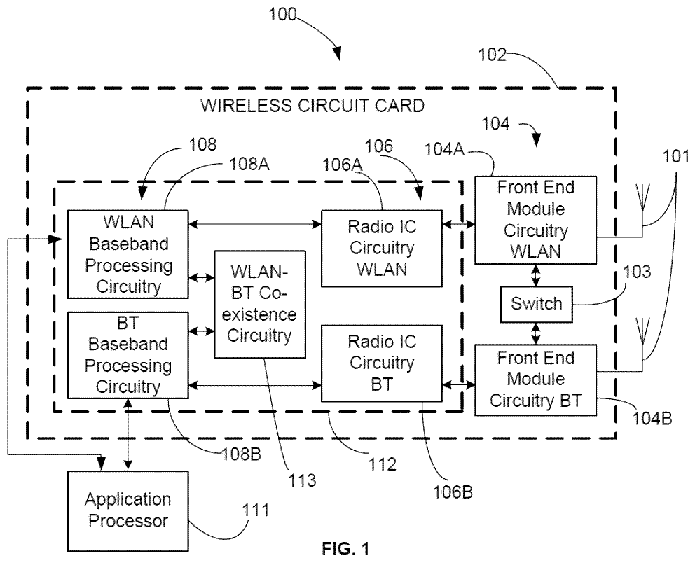

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM CIRCUITRY 104A and FEM CIRCUITRY 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM circuitry 104A or FEM circuitry 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or integrated circuit (IC), such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, IEEE 802.11ax, IEEE P802.11be and/or IEEE P802.11bn standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In some embodiments, the radio architecture 100 may be configured for Extremely High Throughput (EHT) communications in accordance with the IEEE 802.11be standard. In these embodiments, the radio architecture 100 may be configured to communicate in accordance with an OFDMA technique, although the scope of the embodiments is not limited in this respect. In some embodiments, the radio architecture 100 may be configured for next generation vehicle-to-everything (NGV) communications in accordance with the IEEE 802.11bd standard and one or more stations including AP 502 may be next generation vehicle-to-everything (NGV) stations (STAs).

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards.

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHZ, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies, however.

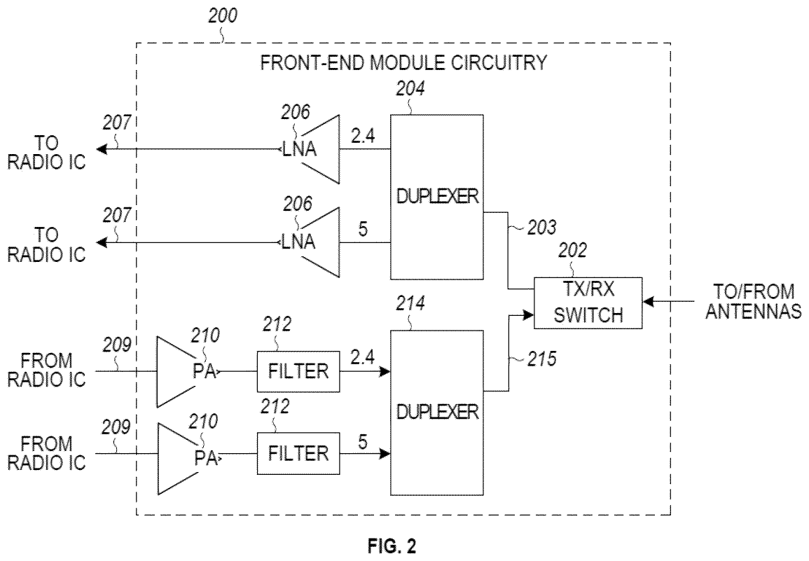

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

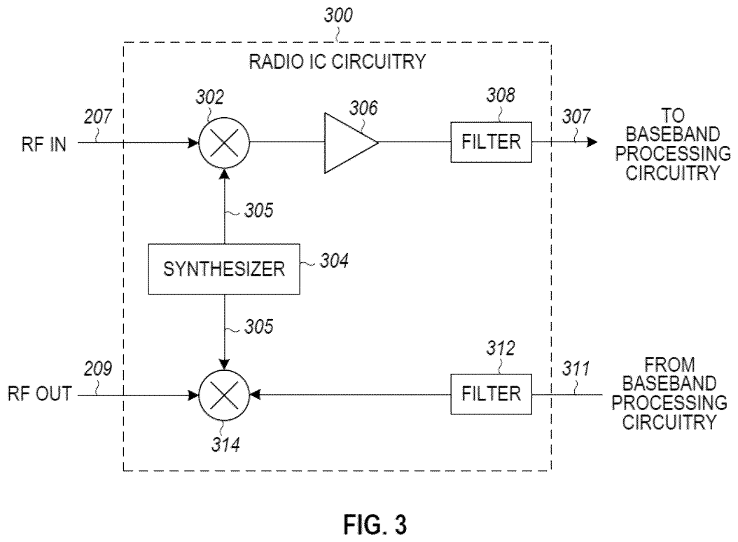

FIG. 3 illustrates radio IC circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage-controlled oscillator (VCO), although that is not a requirement. A divider control input may further be provided by either the baseband processing circuitry 108 (FIG. 1) or application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

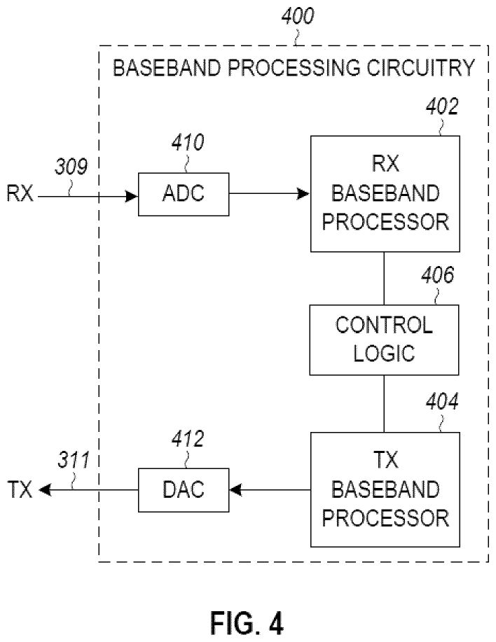

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processing circuitry 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

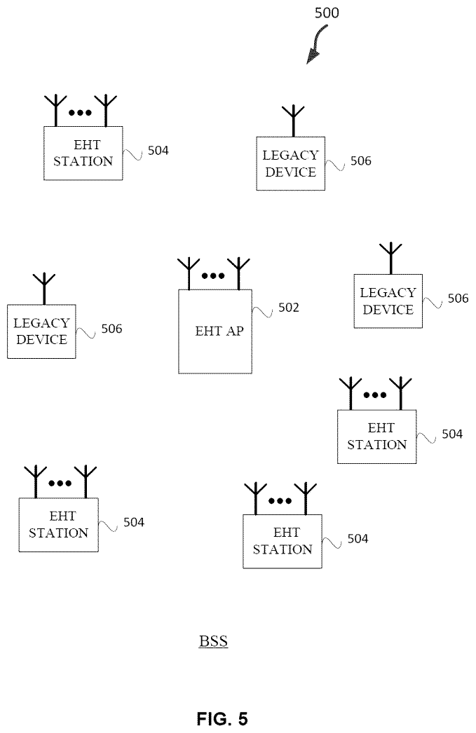

FIG. 5 illustrates a WLAN 500 in accordance with some embodiments. The WLAN 500 may comprise a basis service set (BSS) that may include an access point (AP) 502, which may be an AP, a plurality of stations 504, and a plurality of legacy (e.g., IEEE 802.11n/ac/ax) devices 506. In some embodiments, WLAN 500 may be configured for Extremely High Throughput (EHT) communications in accordance with the IEEE 802.11be standard and one or more stations including AP 502 and stations 504 may be EHT STAs. In some embodiments, WLAN 500 may be configured for Ultra-High Rate (UHR) communications in accordance with one of the IEEE 802.11 standards or draft standards and one or more stations including AP 502 and stations 504 may be UHR and/or UHR+ STAs.

In some embodiments, WLAN 500 may be configured for next generation vehicle-to-everything (NGV) communications in accordance with the IEEE 802.11bd standard and one or more stations including AP 502 may be next generation vehicle-to-everything (NGV) stations (STAs).

The AP 502 may be an AP using the IEEE 802.11 to transmit and receive. The AP 502 may be a base station. The AP 502 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502.

The legacy devices 506 may operate in accordance with one or more of IEEE 802.11 wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the STAs 504 may be termed high efficiency (HE) stations.

AP 502 may communicate with legacy devices 506 in accordance with legacy IEEE 802.11 communication techniques. In example embodiments, AP 502 may also be configured to communicate with STAs 504 in accordance with legacy IEEE 802.11 communication techniques.

In some embodiments, a frame may be configurable to have the same bandwidth as a channel. The frame may be a physical Layer Convergence Procedure (PLCP) Protocol Data Unit (PPDU). In some embodiments, there may be several types of PPDUs that may have different fields and different physical layers and/or different media access control (MAC) layers.

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA PPDU formats. In some embodiments, the 106-subcarrier RU is used in the 20 MHz, 40 MHz, 80 MHz, 160 MHz and 80+80 MHz OFDMA and MU-MIMO PPDU formats. In some embodiments, the 242-subcarrier RU is used in the 40 MHz, 80 MHz, 160 MHz and 80+80 MHz OFDMA and MU-MIMO PPDU formats. In some embodiments, the 484-subcarrier RU is used in the 80 MHz, 160 MHz and 80+80 MHz OFDMA and MU-MIMO PPDU formats. In some embodiments, the 996-subcarrier RU is used in the 160 MHz and 80+80 MHz OFDMA and MU-MIMO PPDU formats.

A frame may be configured for transmitting a number of spatial streams, which may be in accordance with MU-MIMO and may be in accordance with OFDMA. In other embodiments, AP 502, STA 504, and/or legacy device 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE and/or EHT communications. In accordance with some IEEE 802.11 embodiments (e.g., IEEE 802.11ax embodiments) a AP 502 may operate as a primary station which may be arranged to contend for a wireless medium (e.g., during a contention period) to receive exclusive control of the medium for an control period. In some embodiments, the control period may be termed a transmission opportunity (TXOP). AP 502 may transmit a master-sync transmission, which may be a trigger frame or control and schedule transmission, at the beginning of the control period. AP 502 may transmit a time duration of TXOP and sub-channel information. During the control period, STAs 504 may communicate with AP 502 in accordance with a non-contention based multiple access technique such as OFDMA or MU-MIMO. This is unlike conventional WLAN communications in which devices communicate in accordance with a contention-based communication technique, rather than a multiple access technique. During the control period, the AP 502 may communicate with STAs 504 using one or more frames. During the control period, the STAs 504 may operate on a sub-channel smaller than the operating range of the AP 502. During the control period, legacy stations refrain from communicating. The legacy stations may need to receive the communication from the AP 502 to defer from communicating.

In accordance with some embodiments, during TXOP the STAs 504 may contend for the wireless medium with the legacy devices 506 being excluded from contending for the wireless medium during the master-sync transmission. In some embodiments the trigger frame may indicate an uplink (UL) UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or non-legacy stations 504 in accordance with legacy IEEE 802.11 communication techniques. In some embodiments, the AP 502 may also be configurable to communicate with STAs 504 outside the TXOP in accordance with legacy IEEE 802.11 communication techniques, although this is not a requirement. Some embodiments are directed to an apparatus of a STA configured for operation in a WLAN comprising processing circuitry and memory. In some embodiments station 504 may be a “group owner” (GO) for peer-to-peer modes of operation. A wireless device may be a station 504 or a AP 502.

In some embodiments, the station 504 and/or AP 502 may be configured to operate in accordance with IEEE 802.11mc. In example embodiments, the radio architecture of FIG. 1 is configured to implement the station 504 and/or the AP 502. In example embodiments, the front-end module circuitry of FIG. 2 is configured to implement the station 504 and/or the AP 502. In example embodiments, the radio IC circuitry of FIG. 3 is configured to implement the station 504 and/or the AP 502. In example embodiments, the base-band processing circuitry of FIG. 4 is configured to implement the station 504 and/or the AP 502.

In example embodiments, the Stations 504, AP 502, an apparatus of the Stations 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein.

In example embodiments, the station 504 and/or the AP 502 are configured to perform the methods and operations/functions described herein. In example embodiments, an apparatus of the station 504 and/or an apparatus of the AP 502 are configured to perform the methods and functions described herein. The term Wi-Fi may refer to one or more of the IEEE 802.11 communication standards. AP and STA may refer to AP 502 and/or STA 504 as well as legacy devices 506.

In some embodiments, the AP and STAs may communicate in accordance with one of the IEEE 802.11 standards. IEEE Std 802.11-2020, IEEE P802.11ax/D8.0, October 2020, IEEE P802.11REVmd/D5.0, IEEE P802.11be/D7.0, August 2024 and IEEE P802.11-REVme/D1.3 are incorporated herein by reference in their entireties.

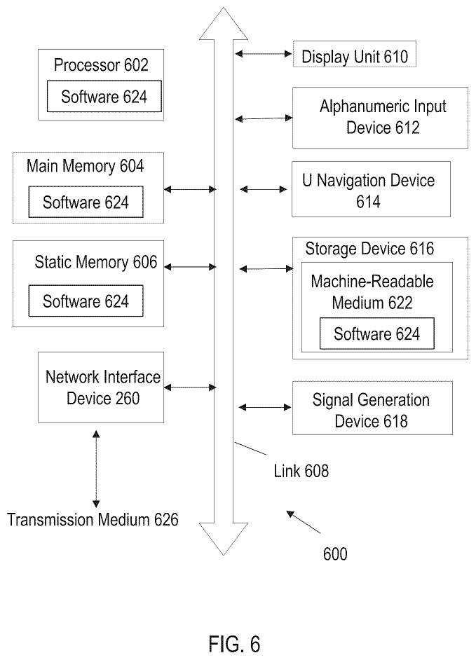

FIG. 6 illustrates a block diagram of a communication device in accordance with some embodiments. The communication device 600 may be a user equipment (UE) or STA such as a specialized computer, a personal or laptop computer (PC), a tablet PC, or a smart phone, dedicated network equipment, a server running software to configure the server to operate as a network device, a virtual device, or any machine capable of executing instructions (sequential or otherwise) that specify actions to be taken by that machine. For example, the communication device 600 may be implemented as one or more of the devices described herein. Note that communications described herein may be encoded before transmission by the transmitting entity for reception by the receiving entity and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 600 may include a hardware processor (or equivalently processing circuitry) 602 (e.g., a central processing unit (CPU), a GPU, a hardware processor core, or any combination thereof), a main memory 604 and a static memory 606, some or all of which may communicate with each other via an interlink (e.g., bus) 608. The main memory 604 may contain any or all of removable storage and non-removable storage, volatile memory or non-volatile memory. The communication device 600 may further include a display unit 610 such as a video display, an alphanumeric input device 612 (e.g., a keyboard), and a user interface (UI) navigation device 614 (e.g., a mouse). In an example, the display unit 610, input device 612 and UI navigation device 614 may be a touch screen display. The communication device 600 may additionally include a storage device (e.g., drive unit) 616, a signal generation device 618 (e.g., a speaker), a network interface device 620, and one or more sensors, such as a global positioning system (GPS) sensor, compass, accelerometer, or another sensor. The communication device 600 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 616 may include a non-transitory machine readable medium 622 (hereinafter simply referred to as machine readable medium) on which is stored one or more sets of data structures or instructions 624 (e.g., software) embodying or utilized by any one or more of the techniques or functions described herein. The non-transitory machine readable medium 622 is a tangible medium. The instructions 624 may also reside, completely or at least partially, within the main memory 604, within static memory 606, and/or within the hardware processor 602 during execution thereof by the communication device 600. While the machine readable medium 622 is illustrated as a single medium, the term “machine readable medium” may include a single medium or multiple media (e.g., a centralized or distributed database, and/or associated caches and servers) configured to store the one or more instructions 624.

The term “machine readable medium” may include any medium that is capable of storing, encoding, or carrying instructions for execution by the communication device 600 and that cause the communication device 600 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 624 may further be transmitted or received over a communications network using a transmission medium 626 via the network interface device 620 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5th generation (5G) standards among others. In an example, the network interface device 620 may include one or more physical jacks (e.g., Ethernet, coaxial, or phone jacks) or one or more antennas to connect to the transmission medium 626.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to 3GPP and IEEE-based standards. Aspects described herein may be used in the context of any spectrum management scheme including, for example, dedicated licensed spectrum, unlicensed spectrum, and license exempt spectrum, (licensed) shared spectrum.

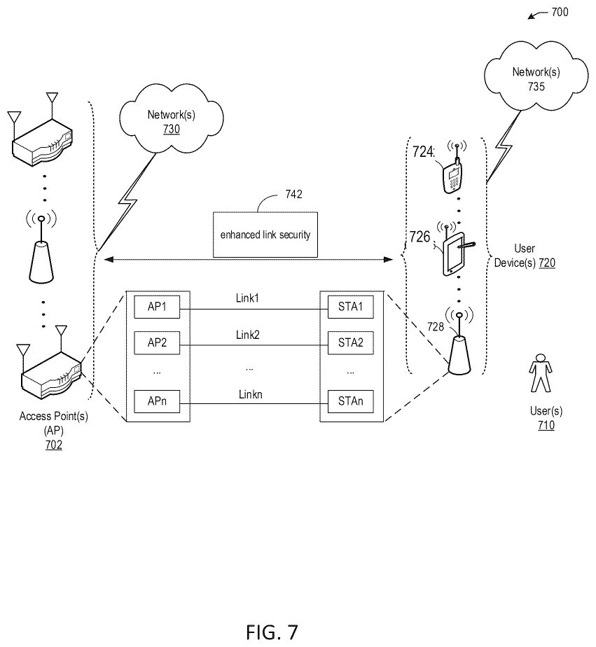

FIG. 7 illustrates network environment of enhanced link security in accordance with some embodiments. Wireless network 700 may include one or more user devices 720 and one or more access points(s) (AP) 702, which may communicate in accordance with IEEE 802.11 communication standards. The user device(s) 720 may be mobile devices that are non-stationary (e.g., not having fixed locations) or may be stationary devices.

One or more illustrative user device(s) 720 and/or AP(s) 702 may be operable by one or more user(s) 710. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 720 and the AP(s) 702 may be STAs. The one or more illustrative user device(s) 720 and/or AP(s) 702 may operate as a personal basic service set (PBSS) control point/access point (PCP/AP). The user device(s) 720 (e.g., 724, 726, or 728) and/or AP(s) 702 may include any suitable processor-driven device including, but not limited to, a mobile device or a non-mobile, e.g., a static device. For example, user device(s) 720 and/or AP(s) 702 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 720 and/or AP(s) 702 may also include mesh stations in, for example, a mesh network, in accordance with one or more IEEE 802.11 standards and/or 3GPP standards.

Any of the user device(s) 720 (e.g., user devices 724, 726, 728), and AP(s) 702 may be configured to communicate with each other via one or more communications networks 730 and/or 735 wirelessly or wired. The user device(s) 720 may also communicate peer-to-peer or directly with each other with or without the AP(s) 702. Any of the communications networks 730 and/or 735 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 730 and/or 735 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 730 and/or 735 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 720 (e.g., user devices 724, 726, 728) and AP(s) 702 may include one or more communications antennas. The one or more communications antennas may be any suitable type of antennas corresponding to the communications protocols used by the user device(s) 720 (e.g., user devices 724, 726 and 728), and AP(s) 702. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 720 and/or AP(s) 702.

Any of the user device(s) 720 (e.g., user devices 724, 726, 728), and AP(s) 702 may be configured to perform directional transmission and/or directional reception in conjunction with wirelessly communicating in a wireless network. Any of the user device(s) 720 (e.g., user devices 724, 726, 728), and AP(s) 702 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 720 (e.g., user devices 724, 726, 728), and AP(s) 702 may be configured to perform any given directional transmission towards one or more defined transmit sectors. Any of the user device(s) 720 (e.g., user devices 724, 726, 728), and AP(s) 702 may be configured to perform any given directional reception from one or more defined receive sectors.

MIMO beamforming in a wireless network may be accomplished using RF beamforming and/or digital beamforming. In some embodiments, in performing a given MIMO transmission, user devices 720 and/or AP(s) 702 may be configured to use all or a subset of its one or more communications antennas to perform MIMO beamforming.

Any of the user devices 720 (e.g., user devices 724, 726, 728), and AP(s) 702 may include any suitable radio and/or transceiver for transmitting and/or receiving radio frequency (RF) signals in the bandwidth and/or channels corresponding to the communications protocols utilized by any of the user device(s) 720 and AP(s) 702 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, 802.11bn, etc.), 6 GHz channels (e.g., 802.11ax, 802.11be, 802.11bn, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 7, a user device 120 may be in communication with one or more APs 702. For example, one or more APs 702 may implement an enhanced link security 742 with one or more user devices 720. The one or more APs 702 may be multi-link devices (MLDs) and the one or more user device 720 may be non-AP MLDs. Each of the one or more APs 702 may comprise a plurality of individual APs (e.g., AP1, AP2, . . . , APn, where n is an integer) and each of the one or more user devices 720 may comprise a plurality of individual STAs (e.g., STA1, STA2, . . . , STAn). The AP MLDs and the non-AP MLDs may set up one or more links (e.g., Link1, Link2, . . . , Linkn) between each of the individual APs and STAs. It is understood that the above descriptions are for the purposes of illustration and are not meant to be limiting.

As above, Wi-Fi 8 (e.g., IEEE 802.11bn, 802.11bi) is the next generation of Wi-Fi and a successor to the IEEE 802.11be (Wi-Fi 7) standard. In line with all previous Wi-Fi standards, Wi-Fi 8 aims to improve wireless performance in general along with introducing new features to further advance Wi-Fi technology.

Pairwise Master Key Identifier (PMKID) is used for PMKSA caching. The PMKID is carried as part of the Robust Security Network information element (RSN IE) in association and Reassociation request frames. The PMKID is used by the AP to decide whether the full 802.1X/EAP (or PSK) authentication may be avoided and the 4-way handshake using a cached PMKSA may be immediately used. The PMKID inside the RSN IE PMKID List field in the (Re)Association Request frame. The association and Reassociation response frames do not echo the PMKID; they simply indicate success/failure at the MAC layer and then, if the PMKID was accepted, the AP immediately starts the 4-way handshake.

In general, after a successful initial authentication and 4-way handshake, the STA and AP share a PMK and create a Pairwise Master Key Security Association (PMKSA) for that STA-BSSID pair. As part of that PMKSA, a PMKID is computed using a function of the PMK and identifiers (including the AP's MAC/BSSID and STA MAC), making the PMKID unique per AP. If a STA returns to an AP where it already has a PMKSA, the STA can send an Association Request with the PMKID in the RSN IE PMKID List. In this case, the AP checks the PMKID against its PMKSA cache; if there is a valid PMKSA, the AP accepts the association and directly initiates the 4-way handshake instead of running full 802.1X/EAP again. If the PMKID is missing, invalid, or not recognized (for example, the AP has no matching PMKSA or validation is disabled), the AP falls back to full authentication (802.1X/EAP or PSK).

When a STA roams from one AP to another in the same ESS and has a cached PMKSA for the target AP, the STA includes the PMKID in the RSN IE of the Reassociation Request. The AP receiving the Reassociation Request validates the PMKID: the AP either recomputes the expected PMKID from the relevant PMKSA or derives the appropriate PMKID from another cached PMKSA (e.g., OKC using a controller). If the PMKID is accepted, the AP responds with a Reassociation Response indicating success and immediately starts the 4-way handshake; if not, the STA performs a full authentication exchange instead.

The PMKID is generally provided in a particular frame sent in the clear for the peer device to identify the previously-established PMKSA. Since the PMKID is sent in the clear, if the PMKID does not change, then the PMKID is a fixed identifier that can be used for tracking. IEEE 802.11bi currently has the PMKID to be used next time delivered by the AP or AP MLD to avoid tracking.

After the indicated PMKID in a Robust Security Network Element (RSNE) identifies a cached PMKSA (see IEEE 802.11bi section 12.6.8.3 (Cached PMKSAs and RSNA key management)), and a Pairwise Transient Key Security Association (PTKSA) is established using the identified PMKSA, different operations may be performed depending on whether Multi-Link Operation (MLO) is used. The PTKSA is a result of a successful 4-way handshake, FT 4-way handshake, FT authentication sequence, FILS authentication, or PASN authentication, EPPKE authentication, or authentication followed by the encrypted (Re)Association Request/Response frame exchange. An Identity Key Security Association is a result of a successful group key handshake with a BPE AP MLD, or the encrypted (Re) association Response frame specified in IEEE 802.11bi section 12.16.6.3 (MLO procedure).

MLO involves procedures where a Multi-Link Device (MLD) associates and operates across multiple links (e.g., 2.4 GHz, 5 GHZ, 6 GHZ) simultaneously or dynamically. Operations include association on multiple links via a single MLD MAC address, packet-level aggregation across links for the same traffic identifier (TID), flow-level aggregation for mesh backhaul, and modes like STR (Simultaneous Transmit/Receive with independent backoffs per link), NSTR (primary link backoff with opportunistic secondary use), EMLSR (enhanced single-radio listening on multiple links but TDM data), and MLSR (basic single-radio switching). Non-MLO procedures follow single-link operation (SLO), where devices use one link at a time without coordination across bands. Operations include independent association per band/channel, separate backoffs and contention per link, no aggregation across links, and static band steering without simultaneous use.

For non-MLO, if the Enhanced Data Privacy (EDP) non-AP STA and the EDP AP set the PMKSA Caching Privacy Support field in the Robust Security Network Extension Element (RSNXE) to 1, the EDP AP delivers the PMKID for the identified PMKSA to be used next time to the non-AP STA in the PMKID Key Derivation Element (KDE) included in the key delivery element of the encrypted (Re)Association Response frame. The RSNXE is an 802.11 information element used to advertise extra RSN capabilities beyond what fits in the main RSN Element. The RSNXE is carried in IEEE 802.11 management frames (e.g., beacons and probe responses) alongside the RSNE and includes the element ID, length, version, Protected Element IDs for privacy-protected elements, Identifier Privacy MIC for securing PMK identifiers, and PMKSA Caching Privacy Support fields, among others. For MLO, if the EDP non-AP STA(s) affiliated with an EDP non-AP MLD and the EDP AP(s) affiliated with an EDP AP MLD set the PMKSA Caching Privacy Support field in the RSNXE to 1, the EDP AP MLD delivers the PMKID for the identified PMKSA to be used next time to the non-AP MLD in the PMKID KDE included in the key delivery element of the encrypted (Re)Association Response frame.

In either case, however, the delivered PMKID is solely determined by the AP or AP MLD. That is, the PMKID computation does not use any input (e.g. a random input) of the non-AP STA or the non-AP MLD, rather being solely determined by the non-AP MLD to ensure randomness. In addition, the AP MLD may not faithfully provide a random PMKID, leading to authentication issues.

In some examples, the PMKID may be recomputed as:

$$PMKID = Truncate - 128 ( HMAC - Hash ( Keyname , “ PMK Name ” ‖ ANonce ‖ SNonce ) )$$

where the HMAC (Hash-based Message Authentication Code) is a keyed hash used to authenticate data and check integrity, the PMK Name is a fixed, standardized literal string that identifies the PMK, and the PMK Name, ANonce, and SNonce are concatenated.

Hash is the hash algorithm from the key derivation type (see IEEE 802.11bi Table 9-190 (AKM suiteselectors)) for each AKM,

Keyname is the key stored as PMK or Master Pairwise Master Key (MPMK) in the PMKSA (see IEEE 802.11bi section 12.6.1.1.2 (PMKSA)),

ANonce is the Authenticator nonce used when the current PTKSA was established, where a nonce is a structured field within authentication, association, or key exchange frames that carries a random or pseudo-random nonce value, typically 32 bytes long, to ensure freshness, uniqueness, and replay protection in security handshakes, and

SNonce is the Supplicant nonce used when the current PTKSA was established.

However, several further issues may exist with this computation of the PMKID. One issue is that the keyname may be the PMK and, as a result, the PMKID may leak information of the PMK. Another issue is that the formula uses the ANonce and SNonce, but during negotiation of the Encrypted Data for Protected Key Establishment (EDPKE), which utilizes the Pre-Association Security Negotiation (PASN) mechanism, there is no exchange of nonce value.

To address these issues, random numbers are exchanged during the encrypted (re) association request/response to derive the PMKID. After the indicated PMKID in an RSNE identifies a cached PMKSA (see IEEE 802.11bi section 12.6.8.3 (Cached PMKSAs and RSNA key management)), and a PTKSA is established using the identified PMKSA, different operations again occur depending on whether MLO is used.

For non-MLO operation, if the EDP non-AP STA and the EDP AP set the PMKSA Caching Privacy Support field in the RSNXE to 1, the EDP non-AP STA includes the nonce element in the (Re)Association Request frame. The EDP AP additionally includes the nonce element in the (Re)Association Response frame. Thus, both the EDP non-AP STA and the EDP AP change the PMKID for the identified PMKSA to be used next time.

For MLO operation, if the EDP non-AP STA(s) affiliated with an EDP non-AP MLD and the EDP AP(s) affiliated with an EDP AP MLD set the PMKSA Caching Privacy Support field in the RSNXE to 1, the EDP non-AP MLD includes the nonce element in the (Re)Association Request frame. The EDP AP MLD also includes the Nonce element in the (Re)Association Response frame. Both the EDP non-AP MLD and the EDP AP MLD change the PMKID for the identified PMKSA to be used next time.

Note that EDP is equivalent to Enhanced Privacy Protection (EPP). Thus, an EPP non-AP STA (or EDP non-AP STA) is a client that implements Enhanced Privacy Protection capabilities. The EPP non-AP STA uses obscured PMKIDs in RSNE during association/Reassociation, supports Identifier Privacy MIC validation, and enables privacy-safe fast roaming across links without exposing persistent identifiers. An EPP AP (or EDP AP STA) is an access point with Enhanced Privacy Protection, validating obscured PMKIDs post-EAPOL handshake and deriving true PMK identifiers only after MIC confirmation. The EPP AP STA signals EPP support via RSNXE or capabilities fields, ensuring compatibility with privacy-aware clients in enterprise or randomized-MAC environments.

The PMKID may be changed in different ways. In a first option,

$$PMKID = Truncate - 128 ( Hash ( PMKIDANonce ‖ PMKIDSNonce ) ) or$$

$$PMKID = Truncate - 128 ( Hash ( “ PMK Name ” ‖ PMKIDANonce ‖ PMKIDSNonce ) ) .$$

In a second option,

$$PMKID = Truncate - 128 ( HMAC - Hash ( PMKIDANonce , PMKIDSNonce ) ) or$$

$$PMKID = Truncate - 128 ( HMAC - Hash ( PMKIDANonce , “ PMK Name ” ‖ PMKIDSNonce ) )$$

In a third option,

$$PMKID = Truncate - 128 ( HMAC - Hash ( PMKIDSNonce , PMKIDANonce ) ) or$$

$$PMKID = Truncate - 128 ( HMAC - Hash ( PMKIDSNonce , “ PMK Name ” ‖ PMKIDSNonce ) )$$

In these options, Hash is the hash algorithm from the key derivation type (see IEEE 802.11bi Table 9-190 (AKM suite selectors)) for each AKM; PMKIDANonce is the Authenticator nonce indicated in the Nonce element in the (Re)Association Response frame used to compute the changed PMKID; and PMKIDSNonce is the Supplicant nonce indicated in the Nonce element in the (Re)Association Request frame used to compute the changed PMKID.

Other issues may arise in FILS public key authentication. FILS public key authentication is an 802.11 authentication method in which, generally, a client authenticates to a network using a public-key-based proof within the FILS Authentication frames, instead of (or in addition to) a long Extensible Authentication Protocol (EAP) exchange. FILS is a protocol used to quickly establish a secure link between devices. At a high level, an AP advertises FILS capability (and which FILS authentication types are supported) in beacons/probe responses. The STA and AP perform FILS Discovery and association (or a combined Authentication/Association if supported). During FILS Authentication, the STA includes a FILS public key authentication element containing its public-key-based proof, and the AP verifies the proof and responds with its own authentication element and keying material. The result is that both sides derive the same pairwise master key (PMK/rMSK) with only a few 802.11 management frames on the air, enabling very fast network access.

The detailed message sequence is standardized in IEEE 802.11ai, but the general pattern for FILS with public key authentication includes a STA to AP Authentication (FILS) request that indicates FILS as the authentication algorithm and includes FILS session parameters. The authentication (FILS) response from the AP to the STA confirms FILS and may provide additional parameters (including selected FILS key derivation options). The STA then sends a FILS Authentication frame with public key authentication element to the AP. The frame carries the STA's contribution to key establishment (nonce, possibly Diffie-Hellman/Elliptic Curve Diffie-Hellman public value) plus the public-key-based proof (signature or encryption). The AP responds with a FILS Authentication frame with AP public key element and key confirmation that carries the AP's key contribution (nonce, DH/ECDH value) and a public-key-based proof over the transcript, allowing the STA to verify the AP and confirm key establishment.

Each FILS public key authentication message carries a FILS Authentication element encapsulated inside the 802.11 management frame body. While the exact bit-level structure is defined in the 802.11ai amendment, the key logical fields include a FILS Session Identifier (a value shared by STA and AP to bind the exchange and avoid replay/mix-up), nonces that include the STA Nonce (N_STA) and AP Nonce (N_AP) used for key derivation and replay protection, key agreement parameters that include public key agreement data such as DH or ECDH public values from STA and AP, the public key identity and algorithm that identifies which public-key pair is used (for example, a certificate reference or key ID) and the signature/encryption algorithm (e.g. RSA or ECDSA plus hash), public-key authentication data that includes a signature (or, in some variants, an encrypted blob) computed over the protocol transcript, including nonces, session ID, and key agreement values, proving possession of the private key corresponding to the advertised public key, and a key confirmation Medium Access Control (MAC) or similar integrity check computed with a provisional session key to confirm that both sides derived the same key material.

The public-key proof in FILS has multiple purposes that include client authentication and key binding. For the first, the STA proves knowledge of the private key associated with a known identity (for example, a certificate subject), enabling the AP or backend AAA server to authenticate the user or device without sending sensitive credentials in clear. For the second, by signing (or encrypting) values that include both parties' nonces, session ID, and key agreement parameters, the STA and AP bind the resulting PMK to this particular exchange, preventing man-in-the-middle and replay attacks.

In practice, the payloads for FILS public key authentication are compact public-key signatures and key agreement parameters embedded in standard 802.11 authentication/association management frames, allowing rapid establishment of authenticated encryption keys at Wi-Fi association time.

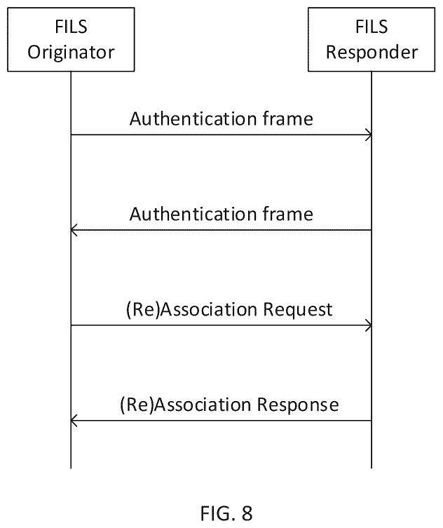

In some examples, the FILS communications may be performed between any two entities. FIG. 8 illustrates a frame exchange in accordance with some embodiments. As shown in FIG. 8, during the FILS public key authentication, the FILS Originator sends the public key or certificate to the FILS responder in the (Re)Association Request frame (the third frame) before verifying the signature in the (Re)Association Response frame (the fourth frame).

The FILS Originator refers to the device initiating the FILS process. The FILS Responder is the device responding to the FILS process. The (Re)Association Request Frame is the third frame in the FILS process where the public key or certificate is sent. The (Re)Association Response Frame is the fourth frame in the FILS process where the signature is verified. The BSS is a set of devices that communicate with each other in a network. The AP, as above, is a device that allows wireless devices to connect to the network.

The first authentication frame provides Diffie-Hellman parameter and Nonce from the FILS Originator. The second authentication frame provides Diffie-Hellman parameter and Nonce from the FILS Responder. Both the FILS Originator and the FILS responder compute the PTKSA using a HMAC and pseudo-random function (PRF) to generate a Pairwise Master Key (PMK) and a Pairwise Transient Key (PTK). The PRF is a keyed function used to generate cryptographically strong, unpredictable bytes such as keys or nonces.

$$PMK = HMAC - Hash ( SNonce ‖ ANonce , DHss )$$

$$PTK = PRF - X ( PMK , “ FILS PTK Derivation ” , SPA ‖ AA ‖ \text{} SNonce ‖ ANonce [ ‖ DHss ] )$$

The key is confirmed in (Re)Association request/response exchange. The (Re)Association Request frame includes public key or certificate in FILS Public Key element and the corresponding signature in the KeyAuth field of the FILS Key Confirmation element.

$$Key - Auth = Sig - STA ( gSTA ‖ gAP ‖ SNonce ‖ ANonce ‖ STA - MAC ‖ AP - BSSID )$$

where Sig-STA( ) indicates a digital signature using the STA's private key, analog to the STA's trusted public key.

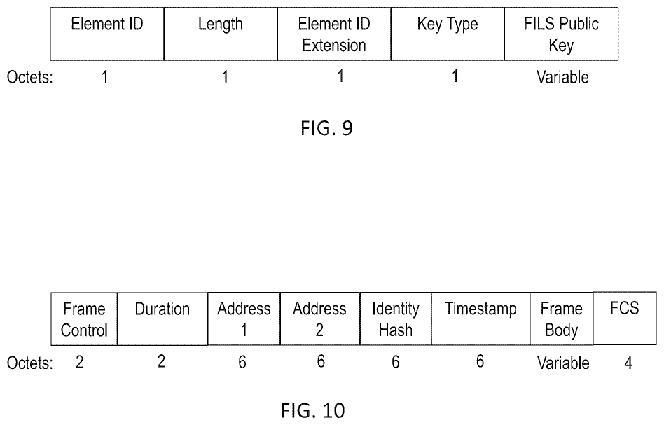

FIG. 9 illustrates a FILS public key element format in accordance with some embodiments. As shown in FIG. 9, the FILS public key element format includes several octets that contain an element ID, length, element ID extension field, key type, and a variable-length FILS public key. The element ID, length, and element ID extension field are defined in IEEE 802.11bi (herein incorporated by reference in its entirety) section 9.4.2.1. The key type field values include 0 which indicates that the field is reserved, 1 which indicates that the FILS public key type field contains an X.509v3 certificate encoded according to IETF RFC 5280, 2 which indicates that the FILS public key type field contains an uncertified public key encoded according to IETF RFC 5480, 3 which indicates that the FILS public key type field contains an uncertified public key encoded according to IETF RFC 3279, and 4-255 which are reserved.

The (Re)Association Response frame includes the FILS public key in FILS Public Key element and the corresponding signature in the KeyAuth field of the FILS Key Confirmation element. The FILS Responder verifies the signature in the (Re)Association Request frame and the FILS Originator verifies the signature in the (Re)Association Response frame. Part of the (Re)Association Request/Response frames are encrypted using the AEAD algorithm.

IEEE 802.11bi introduces a BSS privacy enhancement, where the privacy of an AP is also addressed by encrypting the beacon frame and randomizing the AP address. However, this complicates the performance of initial discovery. To bootstrap the initial operation, an identity key is defined such that the key can be used to discover APs. Specifically, an identity hash is calculated based on the identity key and the randomized MAC address of the AP. The client is then able to discover the desired AP by also computing the identity hash and a preshared identity key.

The BSS privacy enhancements (BPE) allow a non-AP MLD to discover an AP MLD by using the preshared identity key. The identity key presharing, maintenance and update procedures are out of the scope of the IEEE 802.11 specification. FIG. 10 illustrates a privacy beam frame format in accordance with some embodiments. As shown in FIG. 10, the frame format includes octets that include a format control, a duration of the frame, multiple addresses (address 1 and address 2), an identity hash, a timestamp of the transmission, a variable length frame body, and a Frame Check Sequence (FCS). The identity hash is defined by:

$$Identity Hash = Truncate - 48 ( HMAC - SHA - 256 ( Identity Key , “ BPE AP MLD address resolution ” ‖ Address 2 ) )$$

where the identity hash is the value of the identity hash field of the privacy beacon, the identity key is a 128-bit identifier of the BPE AP MLD, and address 2 is the A2 field of the privacy beacon.

However, a privacy issue may occur caused by a fake FILS responder gathering the public key or certificate from the FILS Originator and tracking the FILS Originator. Similar issue exists for BSS privacy enhancement when it is attempted to have privacy for the AP because FILS responder also reveals public key or certificate.

To this end, an enhanced link security system may move the signature in the (Re)Association Response frame to the second authentication. The signature may be encrypted with authenticated encryption with associated data (AEAD) to avoid a third party overhearing the information to preserve the same obscurity from the FILS Responder. As a result, the FILS Originator verifies the FILS responder before sending its own public key or certificate. This addresses the client privacy since the FILS originator is the client (e.g., a non-AP STA or non-AP MLD). The AEAD is cipher mode that performs authenticated encryption of plaintext, with associated data that is authenticated but not encrypted.

For BSS privacy, a fake client (fake FILS originator) may be problematic since the FILS responder initially provides a public key or certificate. Accordingly, an identity key may be used in the PMK or PTK derivation. As a result, fake FILS originators that do not have the identity key cannot derive the proper PMK and consequently cannot decrypt the AEAD encrypted public key or certificate in the authentication frame from the FILS responder.

Starting with the capability indication, a capability bit indication is used to indicate that a FILS Originator or FILS Responder supports the proposed procedures. The capability bit indication can be in the RSNXE or the FILS information field in the FILS indication element. The capability bit may be a new bit or may be reused (retasked) from an existing unused bit in either or both fields. The capability bit can indicate that if 11bi (Re)Association Request/Response encryption is supported, the additional privacy feature is also supported. The FILS Originator and a FILS Responder may perform FILS authentication with perfect forward secrecy (PFS) in response to an Association or Reassociation Frame Encryption Support field in a Robust Security Network Extension Element (RSNXE) being set to 1 by both.

Continuing with the client privacy enhancement for FILS public key authentication, the FILS responder (FILSR) derives the PMK and PTK based on IEEE 802.11bi sections 12.11.2.5.2 (PMKSA key derivation with FILS authentication) and 12.11.2.5.3 (PTKSA Key derivation with FILS authentication) before sending the second authentication frame to the FILS originator (FILSO). Currently, the FILS responder derives the PMK and PTK after transmitting the authentication frame to the FILS originator. A PMKSA association is bidirectional. In other words, both parties use the information in the security association for both sending and receiving. The PMKSA is used to create the PTKSA. PMKSAs have a set lifetime.

The FILSR includes the FILS public key element and FILS key confirmation element in the second authentication frame. The content of the FILS public key element includes the public key or the certificate information. The content of the FILS Confirmation element is as defined in IEEE 802.11bi section 12.11.2.6.3 ((Re)Association Response for FILS key confirmation) depending on whether PMKSA caching is used. Both elements are provided after the FILS session element.

Different options can be used. In a first option, the FILSR encrypts the authentication using the AEAD algorithm defined in IEEE 802.11bi section 12.11.2.7 (AEAD cipher mode for FILS) with the PTK-KEK as the key. In a second option, the PASN encrypted data element is included. The PASN is a mechanism that lets two Wi-Fi devices perform an 802.11 security handshake and derive keys before they actually associate on a BSS, or even while they are associated somewhere else.

In the first option, the Additional Authenticated Data (AAD) used with the AEAD algorithm for the (Re)Association Response frame contains the following data passed as separate components in the following order: FILSR's MAC address, FILSO's MAC address, FILSR's nonce, FILSO's nonce, the contents of the Authentication frame from the Authentication algorithm number field (inclusive) to the FILS Session element (inclusive).

The plaintext passed to the AEAD algorithm is the data that would follow the FILS session element in an unencrypted frame body. The output of the AEAD algorithm becomes the data that follows the FILS session element in the encrypted and authenticated second authentication frame. The output of the algorithm is as specified in IETF RFC 5116. The resulting authentication frame is transmitted to the FILSO.

In the second option, the NIST Advanced Encryption Standard (AES) key wrap is added as potential algorithm to be used for the Key Encryption Key (KEK). In this case, the FILS public key subelement and FILS key confirmation subelement is defined with the same format as FILS public key element and FILS key confirmation element. The encrypted data field of the PASN encrypted data is then encrypted in the second Authentication frame. The KEK, as derived from the PTK, is used with the negotiated key wrap algorithm to encrypt the encrypted data field of the PASN encrypted data element.

If the size of the encrypted data field is larger than 254 octets, then the encrypted data field is encrypted first, then element fragmentation as defined in 802.11bi section 10.28.11 (Element fragmentation) is performed. If the encrypted data field uses the NIST AES key wrap, then the encrypted data field is padded before encrypting if the length of the encrypted data field is nonzero and less than 16 octets, or if the encrypted data field is not a multiple of 8 octets. The padding appends a single octet 0xdd followed by zero or more 0x00 octets. When processing a received PASN encrypted data element, the receiver ignores the trailing padding.

The FILSO follows existing procedures in 802.11bi section 12.11.2.4.5 (Upon receipt) to process the second authentication frame from FILSR. In this case, different options may be used.

In option 1, the FILSO decrypts and verifies the received Authentication frame with the AEAD algorithm as defined in 802.11bi section 12.11.2.5 (Key establishment with FILS authentication) with the PTK-KEK as the key. The AAD is reconstructed as defined above and is passed with the cipher text of the received frame to the AEAD decryption operation.

In option 2, the FILSO unwraps the FILS public key subelement and FILS key confirmation subelement using the NIST AES key wrap algorithm. The FILSO compares the FILS session of the received frame with the FILS Session the FILSO selected to identify the FILS session. If they differ, authentication fails. If the output from the AEAD decryption operation returns an indication of failure, the authentication exchange fails. If the output does not return an indication of failure, the output plaintext replaces the cipher text as the portion of the frame body that follows the FILS session element, and processing of the received frame continues by checking the value of the FILS key confirmation element. The checking procedure is as defined in 802.11bi section 12.11.2.6.3 ((Re)Association Response for FILS key confirmation). If authentication is determined to be a failure, the Integrity Check Key (ICK), PTK-KEK, PMK, and TK are irretrievably deleted, and the STA abandons the exchange. Otherwise, the FILSO continues the transmission of the (Re)Association Request frame.

There is also a mandate to support Encryption of (Re)Association Request/Response frame. If the (Re)Association Request/Response frames are encrypted, then further AEAD encryption for the (Re)Association Request/Response frame is not performed.

Continuing with the BSS privacy enhancement for FILS public key authentication. The procedures of the client privacy enhancement are reused. In this case the PMK and/or PTK derivations may be changed as follows:

$$PMK = HMAC - Has ( SNonce ‖ ANonce ‖ Identity Key , DHss )$$

$$PTK = PRF - X ( PMK , “ FILS PTK Derivation ” , \text{} SPA ‖ AA ‖ SNonce ‖ ANonce ‖ Identity Key [ ‖ DHss ] )$$

This change may be limited to only one of the PMK or PTK, or both may be changed.

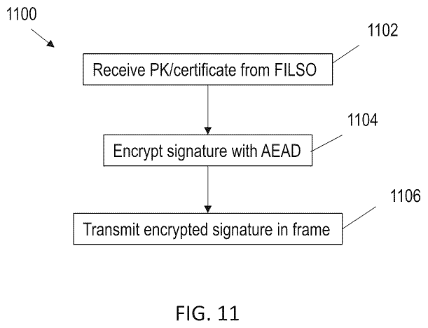

FIG. 11 illustrates a flow diagram for an enhanced link security system, in accordance with some examples. FIG. 11 only shows some operations of the method 1100 performed by the STAs; other operations may be present but are not shown for convenience.

At operation 1102, a STA (e.g., the user device, the AP, and/or enhanced link security device) may receive a public key or certificate from a FILS Originator in a frame. The frame may be an Association or Reassociation Request frame as described in the IEEE 802.11bi standard, for example.

At operation 1104, the STA may encrypt a signature with AEAD. The encryption technique may be as described herein.

At operation 1106, the STA may transmit the encrypted signature in an Association or Reassociation Response frame.

It is understood that the above descriptions are for the purposes of illustration and are not meant to be limiting.

### EXAMPLES

Example 1 is a wireless device comprising: a memory configured to store a Pairwise Master Key Identifier (PMKID); and processing circuitry that configures the wireless device to: after establishment of a Pairwise Transient Key Security Association (PTKSA) based on a Pairwise Master Key Security Association (PMKSA) during one of association or Reassociation, determine Nonce elements in a pair of frames, the pair of frames including one of Association Request and Response frames or Reassociation Request and Response frames; and change, based on the Nonce elements, the PMKID for the PMKSA to a new PMKID for a next association and Reassociation.

In Example 2, the subject matter of Example 1 includes, wherein: the processing circuitry is further configured to determine whether a PMKSA Caching Privacy Support field in a Robust Security Network Extension Element (RSNXE) is set to 1, and one of the Nonce elements is included in each of the Association and Reassociation Request and Response frames in response to a determination that the PMKSA Caching Privacy Support field is set to 1.

In Example 3, the subject matter of Example 2 includes, wherein the processing circuitry is further configured to, for non-Multi-Link Operation (MLO): encode a first of the Nonce elements for transmission in the Association Request or Reassociation Request frame and decode a second of the Nonce elements in the Association Response or Reassociation Response frame when the wireless device is an Enhanced Privacy Protection (EPP) non-access point (AP) station (STA), and encode the second of the Nonce elements for transmission in the Association Response or Reassociation Response frame and decode the first of the Nonce elements for transmission in the Association Request or Reassociation Request frame when the wireless device is an EPP AP.

In Example 4, the subject matter of Examples 2-3 includes, wherein the processing circuitry is further configured to, for Multi-Link Operation (MLO): encode a first of the Nonce elements for transmission in the Association Request or Reassociation Request frame and decode a second of the Nonce elements in the Association Response or Reassociation Response frame when the wireless device is an Enhanced Privacy Protection (EPP) non-access point (AP) multi-link device (MLD), and encode the second of the Nonce elements for transmission in the Association Response or Reassociation Response frame and decode the first of the Nonce elements for transmission in the Association Request or Reassociation Request frame when the wireless device is an EPP AP MLD.

In Example 5, the subject matter of Examples 1-4 includes, wherein the processing circuitry is further configured to: decode an indication of a changed Pairwise Master Key Identifier (PMKID) in a Robust Security Network Element (RSNE) that identifies a cached PMKSA; and establish the PTKSA based on the PMKSA.

In Example 6, the subject matter of Examples 1-5 includes, wherein: the Nonce elements include an Authenticator Nonce of an Authenticator in the Association Response or Reassociation Response frame and a Supplicant Nonce of a Supplicant in the Association Request or Reassociation Request frame, and the processing circuitry is configured to calculate the PMKID using a hash function that includes both the Authenticator Nonce and the Supplicant Nonce.

In Example 7, the subject matter of Example 6 includes, wherein the processing circuitry is configured to calculate the PMKID using: PMKID=Truncate-128 (Hash(“PMK Name”∥PMKIDANonce∥PMKIDSNonce)) where Hash is a hash algorithm from a key derivation type, ANonce is the Authenticator nonce used when the PTKSA was established, SNonce is the Supplicant nonce used when the PTKSA was established, and PMK Name is a fixed, standardized string that identifies a Pairwise Master Key (PMK) used for the PMKSA.

In Example 8, the subject matter of Examples 1-7 includes, wherein the processing circuitry is further configured to set an Association or Reassociation Frame Encryption Support field in a Robust Security Network Extension Element (RSNXE) to 1 in response to a PMKSA Caching Privacy Support field in the RSNXE being set to 1.

Example 9 is a non-transitory computer-readable storage medium that stores instructions for execution by a processor of a wireless device, the instructions, when executed, cause the wireless device to: after establishment of a Pairwise Transient Key Security Association (PTKSA) based on a Pairwise Master Key Security Association (PMKSA) during one of association or Reassociation, determine Nonce elements in a pair of frames, the pair of frames including one of Association Request and Response frames or Reassociation Request and Response frames; and change, based on the Nonce elements, a Pairwise Master Key Identifier (PMKID) for the PMKSA for use in a next association or Reassociation.

In Example 10, the subject matter of Example 9 includes, wherein the instructions, when executed, cause the processor to set an Association or Reassociation Frame Encryption Support field in a Robust Security Network Extension Element (RSNXE) to 1 in response to a PMKSA Caching Privacy Support field in the RSNXE being set to 1.

In Example 11, the subject matter of Examples 9-10 includes, wherein: the instructions, when executed, cause the processor to determine whether a PMKSA Caching Privacy Support field in a Robust Security Network Extension Element (RSNXE) is set to 1, and one of the Nonce elements is included in each of the Association and Reassociation Request and Response frames in response to a determination that the PMKSA Caching Privacy Support field is set to 1.

In Example 12, the subject matter of Example 11 includes, wherein for non-Multi-Link Operation (MLO), the instructions, when executed, cause the processor, encode a first of the Nonce elements for transmission in the Association Request or Reassociation Request frame and decode a second of the Nonce elements in the Association Response or Reassociation Response frame when the wireless device is an Enhanced Privacy Protection (EPP) non-access point (AP) station (STA), and encode the second of the Nonce elements for transmission in the Association Request or Reassociation frame Response and decode the first of the Nonce elements for transmission in the Association Response or Reassociation Request frame when the wireless device is an EPP AP.

In Example 13, the subject matter of Examples 11-12 includes, wherein for Multi-Link Operation (MLO), the instructions, when executed, cause the processor, encode a first of the Nonce elements for transmission in the Association Request or Reassociation Request frame and decode a second of the Nonce elements in the Association Response or Reassociation Response frame when the wireless device is an Enhanced Privacy Protection (EPP) non-access point (AP) multi-link device (MLD), and encode the second of the Nonce elements for transmission in the Association Request or Reassociation frame Response and decode the first of the Nonce elements for transmission in the Association Response or Reassociation Request frame when the wireless device is an EPP AP MLD.

In Example 14, the subject matter of Examples 10-13 includes, wherein the instructions, when executed, cause the processor to: decode an indication of a changed Pairwise Master Key Identifier (PMKID) in a Robust Security Network Element (RSNE) that identifies a cached PMKSA; and establish the PTKSA based on the PMKSA.

In Example 15, the subject matter of Examples 10-14 includes, wherein: the Nonce elements include an Authenticator Nonce of an Authenticator in the Association Response or Reassociation Response frame and a Supplicant Nonce of a Supplicant in the Association Request or Reassociation Request frame, and the instructions, when executed, cause the processor to calculate the PMKID using a hash function that includes both the Authenticator Nonce and the Supplicant Nonce.

Example 16 is non-transitory computer-readable storage medium of Example 15, wherein the instructions, when executed, cause the processor to calculate the PMKID using: PMKID=Truncate 128 (Hash(“PMK Name”∥PMKIDANonce∥PMKIDSNonce)) where Hash is a hash algorithm from a key derivation type, ANonce is the Authenticator nonce used when the PTKSA was established, SNonce is the Supplicant nonce used when the PTKSA was established, and PMK Name is a fixed, standardized string that identifies a Pairwise Master Key (PMK) used for the PMKSA.

Example 17 is a wireless device comprising: a memory configured to store a signature of the wireless device; and processing circuitry that configures the wireless device to: decode an Authentication Request frame from a fast initial link setup (FILS) Originator; encrypt a FILS Public Key element and a FILS Key Confirmation element as an encryption; and encode the encryption for transmission in an Authentication Response frame for transmission to the FILS Originator.

In Example 18, the subject matter of Example 17 includes, wherein the processing circuitry is further configured to determine, based on reception of a capability bit in the Authentication Request frame, that the FILS Originator supports authentication via reception of the encrypted FILS Public Key element and FILS Key Confirmation element prior to transmission of an Association or Reassociation Request frame.

In Example 19, the subject matter of Example 18 includes, wherein the capability bit is in at least one of a Robust Security Network Extension Element (RSNXE) or a FILS Information field in a FILS Indication element.

In Example 20, the subject matter of Examples 17-19 includes, wherein the processing circuitry is further configured to perform FILS authentication with perfect forward secrecy (PFS) in response to the FILS Originator and a FILS Responder setting an Association or Reassociation Frame Encryption Support field in a Robust Security Network Extension Element (RSNXE) to 1.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A wireless device comprising:
a memory configured to store a Pairwise Master Key Identifier (PMKID); and
processing circuitry that configures the wireless device to:
after establishment of a Pairwise Transient Key Security Association (PTKSA) based on a Pairwise Master Key Security Association (PMKSA) during one of association or Reassociation, determine Nonce elements in a pair of frames, the pair of frames including one of Association Request and Response frames or Reassociation Request and Response frames; and
change, based on the Nonce elements, the PMKID for the PMKSA to a new PMKID for a next association and Reassociation.

2. The wireless device of claim 1, wherein:
the processing circuitry is further configured to determine whether a PMKSA Caching Privacy Support field in a Robust Security Network Extension Element (RSNXE) is set to 1, and
one of the Nonce elements is included in each of the Association and Reassociation Request and Response frames in response to a determination that the PMKSA Caching Privacy Support field is set to 1.

3. The wireless device of claim 2, wherein the processing circuitry is further configured to, for non-Multi-Link Operation (MLO):
encode a first of the Nonce elements for transmission in the Association Request or Reassociation Request frame and decode a second of the Nonce elements in the Association Response or Reassociation Response frame when the wireless device is an Enhanced Privacy Protection (EPP) non-access point (AP) station (STA), and
encode the second of the Nonce elements for transmission in the Association Response or Reassociation Response frame and decode the first of the Nonce elements for transmission in the Association Request or Reassociation Request frame when the wireless device is an EPP AP.

4. The wireless device of claim 2, wherein the processing circuitry is further configured to, for Multi-Link Operation (MLO):
encode a first of the Nonce elements for transmission in the Association Request or Reassociation Request frame and decode a second of the Nonce elements in the Association Response or Reassociation Response frame when the wireless device is an Enhanced Privacy Protection (EPP) non-access point (AP) multi-link device (MLD), and
encode the second of the Nonce elements for transmission in the Association Response or Reassociation Response frame and decode the first of the Nonce elements for transmission in the Association Request or Reassociation Request frame when the wireless device is an EPP AP MLD.

5. The wireless device of claim 1, wherein the processing circuitry is further configured to:
decode an indication of a changed Pairwise Master Key Identifier (PMKID) in a Robust Security Network Element (RSNE) that identifies a cached PMKSA; and
establish the PTKSA based on the PMKSA.

6. The wireless device of claim 1, wherein:
the Nonce elements include an Authenticator Nonce of an Authenticator in the Association Response or Reassociation Response frame and a Supplicant Nonce of a Supplicant in the Association Request or Reassociation Request frame, and
the processing circuitry is configured to calculate the PMKID using a hash function that includes both the Authenticator Nonce and the Supplicant Nonce.

7. The wireless device of claim 6, wherein the processing circuitry is configured to calculate the PMKID using:
$$PMKID = Truncate - 128 ( Hash ( “ PMK Name ” ‖ PMKIDANonce ‖ PMKIDSNonce ) )$$
where Hash is a hash algorithm from a key derivation type, ANonce is the Authenticator nonce used when the PTKSA was established, SNonce is the Supplicant nonce used when the PTKSA was established, and PMK Name is a fixed, standardized string that identifies a Pairwise Master Key (PMK) used for the PMKSA.

8. The wireless device of claim 1, wherein the processing circuitry is further configured to set an Association or Reassociation Frame Encryption Support field in a Robust Security Network Extension Element (RSNXE) to 1 in response to a PMKSA Caching Privacy Support field in the RSNXE being set to 1.

9. A non-transitory computer-readable storage medium that stores instructions for execution by a processor of a wireless device, the instructions, when executed, cause the wireless device to:
after establishment of a Pairwise Transient Key Security Association (PTKSA) based on a Pairwise Master Key Security Association (PMKSA) during one of association or Reassociation, determine Nonce elements in a pair of frames, the pair of frames including one of Association Request and Response frames or Reassociation Request and Response frames; and
change, based on the Nonce elements, a Pairwise Master Key Identifier (PMKID) for the PMKSA for use in a next association or Reassociation.

10. The non-transitory computer-readable storage medium of claim 9, wherein the instructions, when executed, cause the processor to set an Association or Reassociation Frame Encryption Support field in a Robust Security Network Extension Element (RSNXE) to 1 in response to a PMKSA Caching Privacy Support field in the RSNXE being set to 1.

11. The non-transitory computer-readable storage medium of claim 9, wherein:
the instructions, when executed, cause the processor to determine whether a PMKSA Caching Privacy Support field in a Robust Security Network Extension Element (RSNXE) is set to 1, and
one of the Nonce elements is included in each of the Association and Reassociation Request and Response frames in response to a determination that the PMKSA Caching Privacy Support field is set to 1.

12. The non-transitory computer-readable storage medium of claim 11, wherein for non-Multi-Link Operation (MLO), the instructions, when executed, cause the processor,
encode a first of the Nonce elements for transmission in the Association Request or Reassociation Request frame and decode a second of the Nonce elements in the Association Response or Reassociation Response frame when the wireless device is an Enhanced Privacy Protection (EPP) non-access point (AP) station (STA), and
encode the second of the Nonce elements for transmission in the Association Request or Reassociation frame Response and decode the first of the Nonce elements for transmission in the Association Response or Reassociation Request frame when the wireless device is an EPP AP.

13. The non-transitory computer-readable storage medium of claim 11, wherein for Multi-Link Operation (MLO), the instructions, when executed, cause the processor,
encode a first of the Nonce elements for transmission in the Association Request or Reassociation Request frame and decode a second of the Nonce elements in the Association Response or Reassociation Response frame when the wireless device is an Enhanced Privacy Protection (EPP) non-access point (AP) multi-link device (MLD), and
encode the second of the Nonce elements for transmission in the Association Request or Reassociation frame Response and decode the first of the Nonce elements for transmission in the Association Response or Reassociation Request frame when the wireless device is an EPP AP MLD.

14. The non-transitory computer-readable storage medium of claim 10, wherein the instructions, when executed, cause the processor to:
decode an indication of a changed Pairwise Master Key Identifier (PMKID) in a Robust Security Network Element (RSNE) that identifies a cached PMKSA; and
establish the PTKSA based on the PMKSA.

15. The non-transitory computer-readable storage medium of claim 10, wherein:
the Nonce elements include an Authenticator Nonce of an Authenticator in the Association Response or Reassociation Response frame and a Supplicant Nonce of a Supplicant in the Association Request or Reassociation Request frame, and
the instructions, when executed, cause the processor to calculate the PMKID using a hash function that includes both the Authenticator Nonce and the Supplicant Nonce.

16. non-transitory computer-readable storage medium of claim 15, wherein the instructions, when executed, cause the processor to calculate the PMKID using:
$$PMKID = Truncate - 128 ( Hash ( “ PMK Name ” ‖ PMKIDANonce ‖ PMKIDSNonce ) )$$
where Hash is a hash algorithm from a key derivation type, ANonce is the Authenticator nonce used when the PTKSA was established, SNonce is the Supplicant nonce used when the PTKSA was established, and PMK Name is a fixed, standardized string that identifies a Pairwise Master Key (PMK) used for the PMKSA.

17. A wireless device comprising:
a memory configured to store a signature of the wireless device; and
processing circuitry that configures the wireless device to:
decode an Authentication Request frame from a fast initial link setup (FILS) Originator;
encrypt a FILS Public Key element and a FILS Key Confirmation element as an encryption; and
encode the encryption for transmission in an Authentication Response frame for transmission to the FILS Originator.

18. The wireless device of claim 17, wherein the processing circuitry is further configured to determine, based on reception of a capability bit in the Authentication Request frame, that the FILS Originator supports authentication via reception of the encrypted FILS Public Key element and FILS Key Confirmation element prior to transmission of an Association or Reassociation Request frame.

19. The wireless device of claim 18, wherein the capability bit is in at least one of a Robust Security Network Extension Element (RSNXE) or a FILS Information field in a FILS Indication element.

20. The wireless device of claim 17, wherein the processing circuitry is further configured to perform FILS authentication with perfect forward secrecy (PFS) in response to the FILS Originator and a FILS Responder setting an Association or Reassociation Frame Encryption Support field in a Robust Security Network Extension Element (RSNXE) to 1.
